(19) United States
(12) Patent Application Publication
(10) Pub. No.: US 2018/0357591 A1
(43) Pub. Date: Dec. 13, 2018

(54) LOCATION DIRECTED OFFERS

(71) Applicant: Amazon Technologies, Inc., Seattle, WA (US)

(72) Inventors: Kristopher William Bell, Seattle, WA (US); Wesley Scott Lauka, Bellevue, WA (US); Joshua Joel Boelter, Seattle, WA (US); Ryan Scott Russell, Seattle, WA (US)

(21) Appl. No.: 14/662,817

(22) Filed: Mar. 19, 2015

(51) Int. Cl. G06Q 10/08; G06Q 30/02

(52) U.S. Cl. CPC G06Q 10/083; G06Q 30/0261

(57) ABSTRACT

Location directed offers are described herein. According to one embodiment, an order for delivery of an item to a delivery location is received. In turn, a route for delivery of the item is evaluated, and computing devices are identified along the route. A subset of the computing devices is selected to receive an offer to purchase an item for expeditious delivery during the carrier's delivery of the item to the delivery location. For efficiency, the subset of computing devices may be selected based on proximity to the route for delivery. Offer notifications are sent to the subset of computing devices and, in response to an acceptance of an offer, the carrier is notified of an additional delivery location for delivery of another item. Thus, upon return of the carrier from delivery of the item, for example, the carrier may also deliver other items along the route.

### BACKGROUND

In some cases, an individual may request delivery of one or more items within a relatively short period of time from when the items are purchased or ordered. Some carrier services may offer same day delivery or delivery within a relatively short timeframe (e.g., hours, minutes, etc.). In that case, a carrier may dispatch a courier, for example, to deliver one or more items to the individual relatively quickly. Same day or short-timeframe deliveries, however, may be relatively costly because a carrier may need to reserve or requisition resources, such as couriers, drivers, delivery vehicles, etc., specifically for the deliveries.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a networked environment for location directed offers according to various example embodiments of the present disclosure.

FIG. 2 illustrates a more detailed view of the networked environment for location directed offers in FIG. 1 according to various example embodiments of the present disclosure.

FIG. 3A illustrates a process of location directed offers performed in the networked environment in FIGS. 1 and 2 according to an example embodiment of the present disclosure.

FIG. 3B further illustrates the process of location directed offers performed in the networked environment in FIGS. 1 and 2 according to an example embodiment of the present disclosure.

FIG. 3C illustrates a process of participant device verification performed in the networked environment in FIGS. 1 and 2 according to an example embodiment of the present disclosure.

FIG. 4 illustrates an example map according to aspects of the process of location directed offers in FIGS. 3A-3C.

FIGS. 5A-F illustrate example user interfaces according to aspects of the processes of location directed offers and participant device verification in FIGS. 3A-3C.

FIG. 6 illustrates an example schematic block diagram of the computing environment employed in the networked environment of FIG. 2 according to various embodiments of the present disclosure.

### DETAILED DESCRIPTION

When using a courier for delivery of an item to a delivery location, the courier's time and effort may be expended entirely for the delivery of the item, because the courier may not have other deliveries along the route to the delivery location. According to the embodiments described herein, to leverage the courier's time and effort in the delivery of an item, offers for other items may be presented to individuals along the carrier's route to the delivery location for the item. The offers may include offers to purchase other items carried by the courier along his route. For efficiency, the offers may be provided to one or more client devices operated by individuals that are located relatively close to or along the carrier's predetermined or expected route.

If one of the offers is accepted, the courier may receive an instruction to deliver one or more other items to a location associated with the client device from which the offer was accepted. Thus, after the courier completes the route for which he originally departed for, he may complete another delivery associated with another transaction at a location associated with the client device. The amount of time between when the offer is provided to the client device and the delivery at or near the location associated with the client device may be relatively small. Using location directed offers as described herein, couriers or carriers may be relied upon to expeditiously deliver items to other willing buyers along routes for other deliveries.

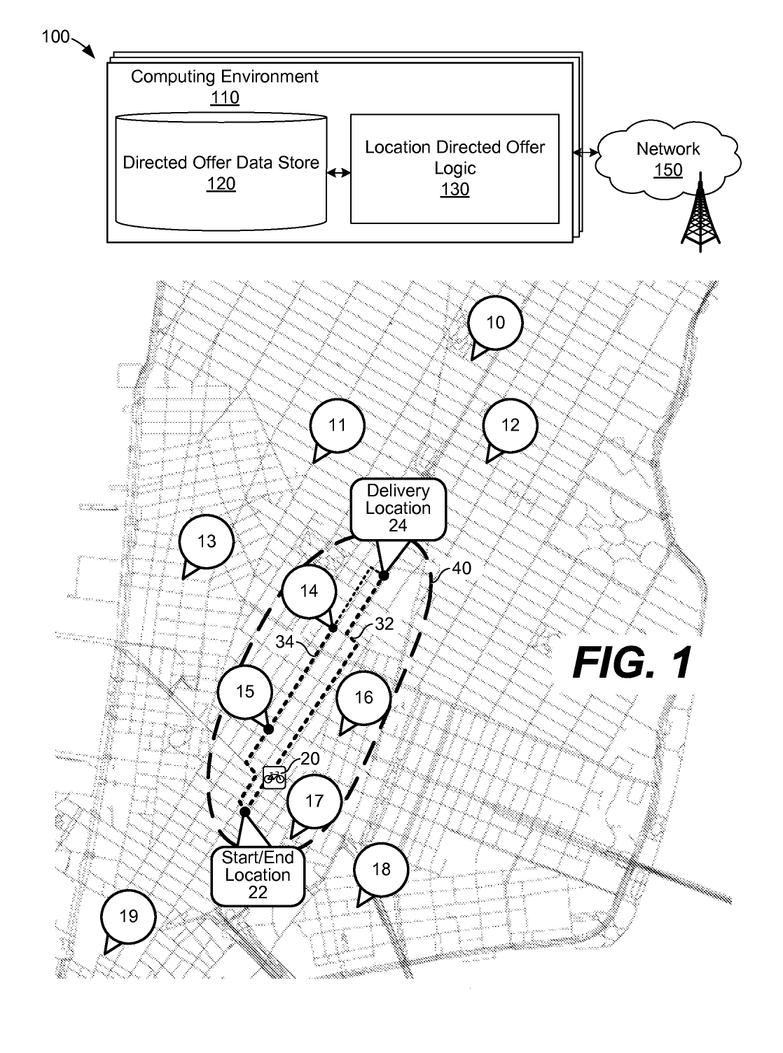

In the context outlined above, further aspects and embodiments of location directed offers are described herein. FIG. 1 illustrates a networked environment 100 for location directed offers according to example embodiments of the present disclosure, along with a map for discussion of the embodiments. The networked environment 100 includes participant client devices 10-19, illustrated at various locations on the map, a computing environment 110, and a network 150. As shown in FIG. 1, the computing environment 110 includes a directed offer data store 120 and location directed offer logic 130. The participant client devices 10-19 may be embodied as mobile computing devices, as further described below, although other types of computing devices are within the scope of the embodiments. The participant client devices 10-19 may each execute a location directed offer application and communicate with the computing environment 110 via the network 150.

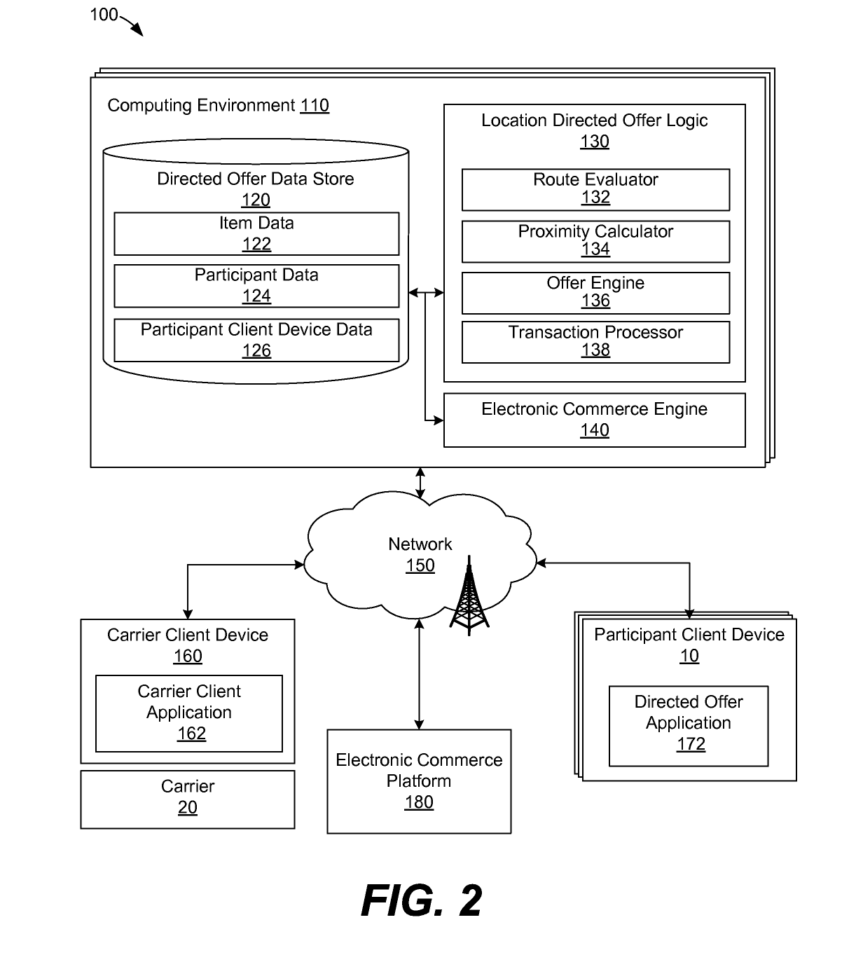

Before turning to a more detailed description of the operation of the networked environment 100 with reference to FIG. 2, a concise description of location directed offers and the advantages thereof are described with reference to FIG. 1. At the outset, an order for delivery of an item to a delivery location 24 may be received by the computing environment 110 or another electronic commerce platform. The order may specify a relatively short timeframe for delivery of the item, such as an hour or less, for example, although longer and shorter delivery times are within the scope of the embodiments.

In turn, the computing environment 110 may provide instructions to a carrier 20 to deliver the item from the start/end location 22, where the item is picked or sourced for delivery, to the delivery location 24. In that context, the carrier 20 may be embodied as any entity that provides delivery services, such as a messenger, courier, express delivery service, or other related or similar delivery service entities. The carrier 20 may deliver the item to the delivery location 24 using any means of transportation, including by foot, bicycle, motor vehicle, etc. It should be appreciated, however, that the embodiments are not limited to delivery services which provide quick or on-demand deliveries. Further, in certain embodiments, the carrier 20 may also include delivery entities such as the United States Postal Service®, the United Parcel Service®, Federal Express®, or other related or similar delivery entities.

Before or during the delivery by the carrier 20, the location directed offer logic 130 may evaluate or estimate a route that the carrier 20 may take to the delivery location 24. The route may include an outbound route 32 and a return route 34, as shown in FIG. 1. The location directed offer logic 130 may then identify the participant client devices 10-19 as being along one or both of the routes 32 and 34. To achieve this, location directed offer logic 130 may reference geographic location information (i.e., global positioning system (GPS) information) from the participant client devices 10-19. In turn, the location directed offer logic 130 may select a subset of the participant client devices 10-19 to receive an offer to purchase an additional item. As one example, the location directed offer logic 130 may select the subset of the participant client devices 10-19 based on individual locations of the participant client devices 10-19. In FIG. 1, the location directed offer logic 130 may select the participant client devices 14-17 as the subset of the participant client devices 10-19 because they are within a certain proximity 40 to the outbound route 32 and the return route 34.

The location directed offer logic 130 may then send offer notifications to the subset of participant client devices 14-17. As described in further detail below, the offer notifications may include offers to purchase items from the carrier 20 for expeditious delivery. In that context, the carrier 20 may carry various items for sale in addition to the item for delivery to the delivery location 24. The additional items may be selected based on the sales velocity (i.e., popularity, sales frequency, etc.) of the additional items, the ability and/or capacity of the carrier 20 to carry or transport the additional items, or other factors.

A user of the participant client device 14, for example, may receive an offer notification, which may include an offer to purchase an item for expeditious delivery, from the location directed offer logic 130 and accept the offer. The acceptance may be communicated to the computing environment 110 via the network 150. In response to the acceptance of the offer, the carrier 20 is notified of an additional delivery location for delivery of the item to a location near the participant client device 14. Thus, upon return of the carrier 20 from the delivery of the item at the delivery location 24, for example, the carrier 20 may also stop at the location of the participant client device 14 to deliver another item.

Thus, according to one aspect of the embodiments, using offers directed to the participant client devices 10-19, the carrier 20 may deliver a number of other items along or near the route to the delivery location 24, without (or substantially or without) impacting the original delivery to the delivery location 24. In that way, the effort of the carrier 20 in delivering to the delivery location 24 may be leveraged for the sale of other items. Further, users of the participant client devices 10-19 may receive the benefit of expeditious delivery at their current locations at a relatively low delivery cost. For example, when the user of the participant client device 14 stops to purchase coffee on his way to work, the user may be presented with an offer to purchase a book for expeditious delivery, and the carrier 20 may deliver the book to the user while he waits for his coffee.

According to another aspect of the embodiments, before the carrier 20 departs from the start/end location 22 to the delivery location 24, the location directed offer logic 130 may identify one or more items which may be likely to be purchased by users of the participant client devices 10-19, based on the purchase histories of the users, and direct the carrier 20 to bring or carry the one or more items. In that way, the location directed offer logic 130 may increase the likelihood that one or more of the users of the participant client devices 10-19 will accept an offer for expeditious delivery.

In still other aspects, after the user of the participant client device 14, for example, accepts an offer to purchase an additional item for expeditious delivery by the carrier 20, the location directed offer logic 130 may calculate an estimated time for delivery of the additional item to the user. The location directed offer logic 130 may also provide updates of the current location of the carrier 20 to the user of the participant client device 14 and give the user an option to cancel the purchase. In that way, if the estimated time is (or becomes) too long, then the user may cancel the order. Further, once the carrier 20 arrives at the location of the participant client device 14, the location directed offer logic 130 may verify the location of the participant client device 14 and/or the user of the participant client device 14. In response to a successful verification, the location directed offer logic 130 may complete a transaction for purchase of the additional item and notify the carrier 20 and the participant client device 14 that the transaction is complete. These and other aspects of the embodiments are described in further detail below with reference to the remaining figures.

FIG. 2 illustrates a more detailed view of the networked environment 100 in FIG. 1 according to various example embodiments of the present disclosure. Beyond the computing environment 110, the network 150, the carrier 20, and the participant client device 10, FIG. 2 illustrates a carrier client device 160 executing a carrier client application 162, and an electronic commerce platform 180. FIG. 2 further illustrates item data 122, participant data 124, and participant client device data 126 of the directed offer data store 120, a route evaluator 132, proximity calculator 134, offer engine 136, and transaction processor 138 of the location directed offer logic 130, and an electronic commerce engine 140 of the computing environment 110.

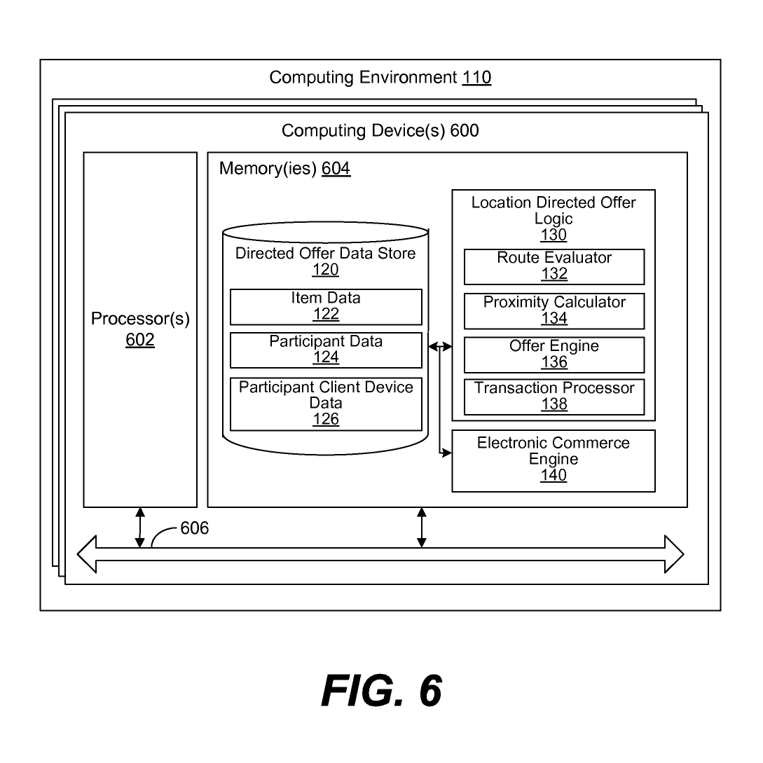

The computing environment 110 may be embodied as one or more computers, computing devices, or computing systems. In certain embodiments, the computing environment 110 may include one or more computing devices arranged, for example, in one or more server or computer banks. The computing device or devices may be located at a single installation site or distributed among different geographical locations. As further described below in connection with FIG. 6, the computing environment 110 may include a plurality of computing devices that together embody a hosted computing resource, a grid computing resource, and/or other distributed computing arrangement. In some cases, the computing environment 110 may be embodied as an elastic computing resource where an allotted capacity of processing, network, storage, or other computing-related resources varies over time. The computing environment 110 may also be embodied, in part, as various functional and/or logic (e.g., computer-readable instruction, device, circuit, processing circuit, etc.) elements configured to direct the computing environment 110 to perform aspects of the embodiments described herein. The operation of the individual components of the computing environment 110 is described in further detail below.

The network 150 may include the Internet, intranets, extranets, wide area networks (WANs), local area networks (LANs), wired networks, wireless (e.g., cellular, 802.11-based (WiFi), bluetooth, etc.) networks, cable networks, satellite networks, other suitable networks, or any combinations thereof. It is noted that the computing environment 110 may communicate with the carrier client device 160, the participant client devices 10, and the electronic commerce platform 180 using various systems interconnect models and/or protocols such as hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), internet protocol (IP), transmission control protocol (TCP), and/or other protocols for communicating data over the network 150, without limitation. It is noted here that, although not illustrated, the network 150 may include connections to any number of network hosts, such as website servers, file servers, networked computing resources, databases, data stores, or any other network or computing architectures.

The carrier client device 160 is representative of one or more client devices which may be relied upon by the carrier 20 to perform, track, and administer deliveries. The carrier client device 160 may be embodied as any type of computing device, processing circuit, or processor based device or system used by the carrier 20, including those embodied in the form of a desktop computer, a laptop computer, a personal digital assistant, a cellular telephone, or a tablet computer, among others. The carrier client device 160 may include one or more system devices or subsystems, such as wireless communications transceivers, GPS receivers, orientation and acceleration sensors, etc. The carrier client device 160 may also include one or more peripheral devices. In this context, the peripheral devices may include one or more input devices, such as a bar or quick response (QR) code scanner, a keyboard, keypad, touch pad, touch screen, microphone, camera, etc.

As illustrated in FIG. 2, the carrier client device 160 may execute applications, such as the carrier client application 162. As further described below, the location directed offer logic 130 may provide data to the carrier client application 162, such as identifiers of one or more items to be delivered, one or more locations to deliver the one or more items, purchaser information, verification information, etc. The location directed offer logic 130 may provide the data to the carrier client application 162 via an applications interface and/or via one or more network pages. In one embodiment, the carrier client application 162 may be embodied as a hypertext-based internet browser, such as Internet Explorer®, Firefox®, Chrome®, Silk®, or another type of browser, or a variant thereof, without limitation. Thus, the carrier client application 162 may render network pages as webpages including user interfaces for interacting with the computing environment 110.

The participant client device 10 is representative of various participant client devices, such as the other participant client devices 11-19 in FIG. 1, for example. The participant client device 10 (and the other participant client devices 11-19) may be embodied as any type of computing device, processing circuit, or processor based device or system, including those embodied in the form of a desktop computer, laptop computer, personal digital assistant, cellular telephone, or tablet computer, among other devices. The participant client device 10 may include one or more devices or subsystems, such as a wireless communication transceiver, GPS receiver, orientation and acceleration sensors, etc. The participant client device 10 may also include one or more peripheral devices, such as a bar or QR code scanner, a keyboard, keypad, touch pad, touch screen, microphone, camera, etc.

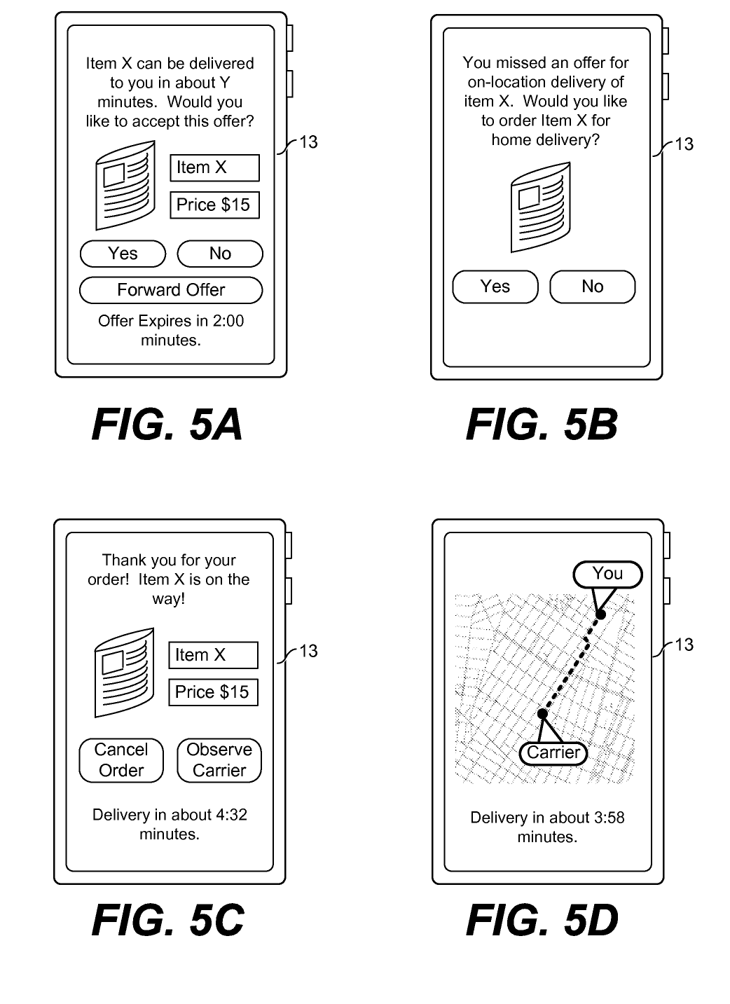

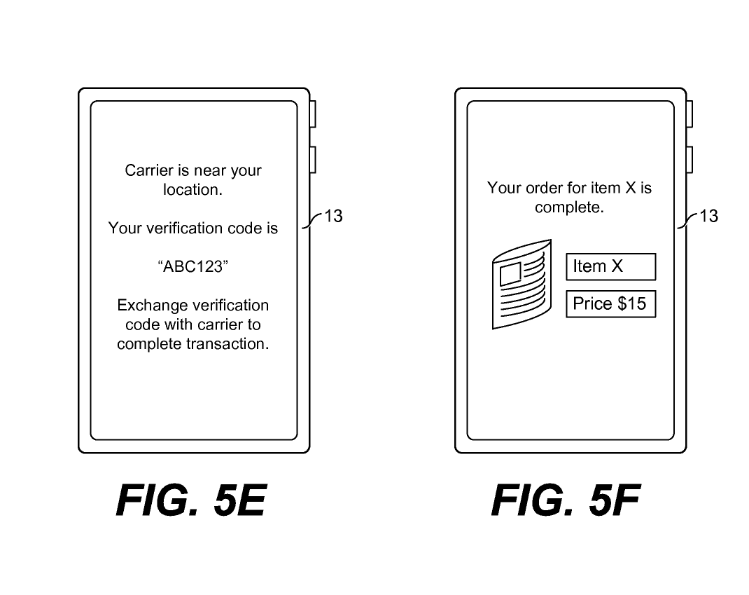

As illustrated in FIG. 2, the participant client device 10 (and the other participant client devices 11-19) may execute various applications, such as the directed offer application 172. As further described below, the location directed offer logic 130 may provide data to the directed offer application 172, such as offer notifications for the purchase of various items, an estimated time of delivery for the items, the location of a carrier, etc. The location directed offer logic 130 may provide the data to the directed offer application 172 via an applications interface and/or via one or more network pages. In one embodiment, the directed offer application 172 may be embodied as a hypertext-based internet browser, such as Internet Explorer®, Firefox®, Chrome®, Silk®, or another type of browser, or a variant thereof, without limitation. Thus, in one embodiment, the directed offer application 172 may render network pages as webpages including user interfaces for interacting with the computing environment 110. In other embodiments, the directed offer application 172 may be embodied as a standalone application on the participant client device 10. Example screenshots of the directed offer application 172, as directed by the location directed offer logic 130, are illustrated in FIGS. 5A-F and described below.

The electronic commerce platform 180 may be embodied as a computer, computing device, or computing system that operates as an electronic commerce platform for selling goods or services. In certain embodiments, the electronic commerce platform 180 may be similar in composition to the computing environment 110, including one or more computing devices arranged, for example, in one or more server or computer banks. Generally, the computing environment 110 may access or refer to the electronic commerce platform 180 to identify user history data, such as that related to the history of browsing activity, interests, or purchases of users, for example.

Turning back to the components of the computing environment 110, the directed offer data store 120 includes item data 122, participant data 124, and participant client device data 126. The item data 122 includes data on various items which may be offered for sale by the electronic commerce engine 140, as described in further detail below. The item data 122 may include price data, quantity data, availability data, item detail data, item location data, item sales volume or velocity data, item review data, etc. for various items. In some embodiments, the item data 122 may include data on items or services sold or performed by one or more vendors and/or service providers at various locations (e.g., from one or more kiosks, brick and mortar stores, restaurants, vendors, fulfillment centers, etc.).

The participant data 124 may include data on one or more users of the participant client devices 10-19. For example, the participant data 124 may include username and password combinations, name, address, and billing information, form of payment information, contact information, purchase history data, etc. Generally, when a user of the participant client device 10, for example, installs the directed offer application 172 for the first time, the user may be requested to agree to certain terms and conditions and create an account with the computing environment 110. The account information for the user may be stored as the participant data 124.

The participant client device data 126 may include data on one or more participant client devices, such as the participant client devices 10-19, among others. For example, the participant client device data 126 may include unique identifier information, such as media access control (MAC) identifier data, device type, model, or operating system information data, software version information, and other related client device data. The participant client device data 126 may also include location information for participant client devices. The location information may include global positioning data (e.g., latitude and longitude data), for example, received from various participant client devices over time.

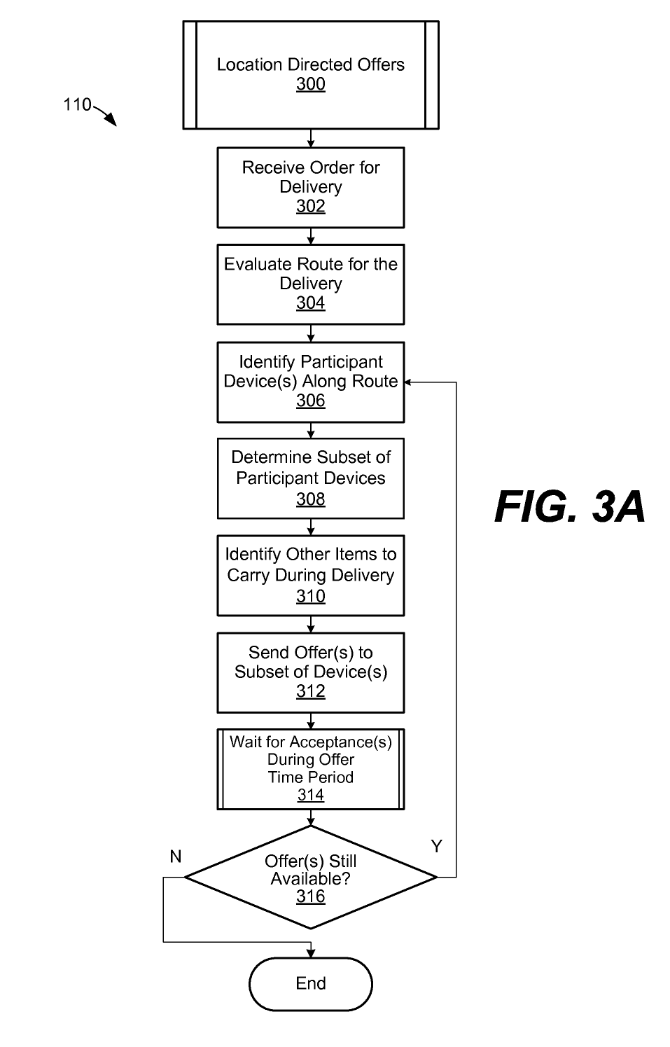

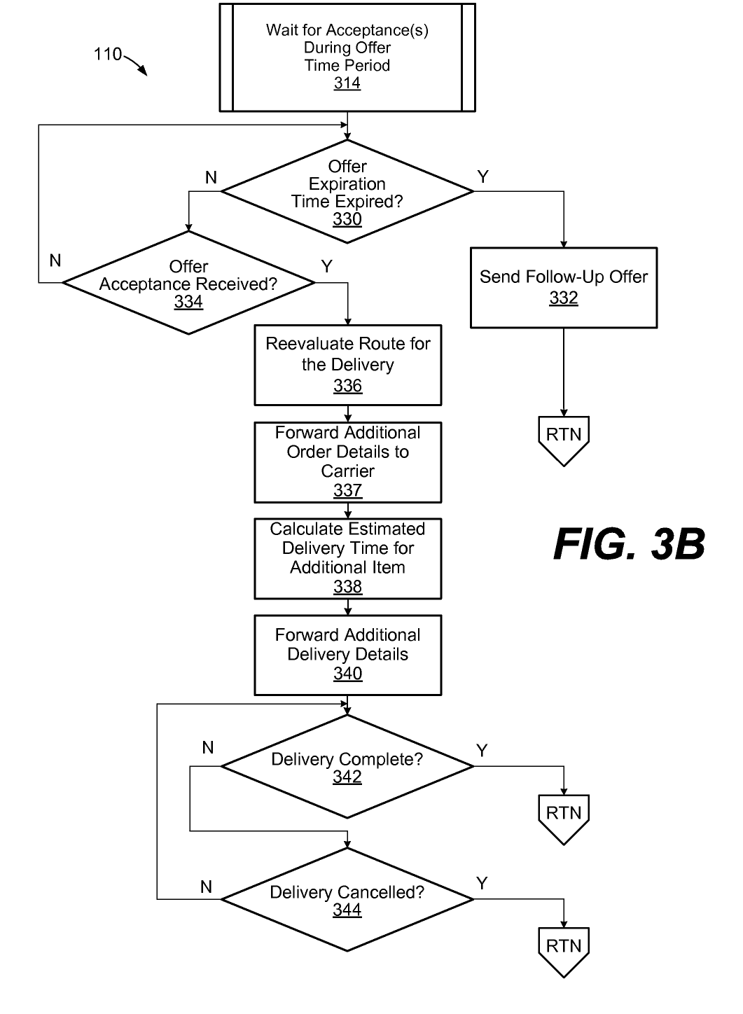

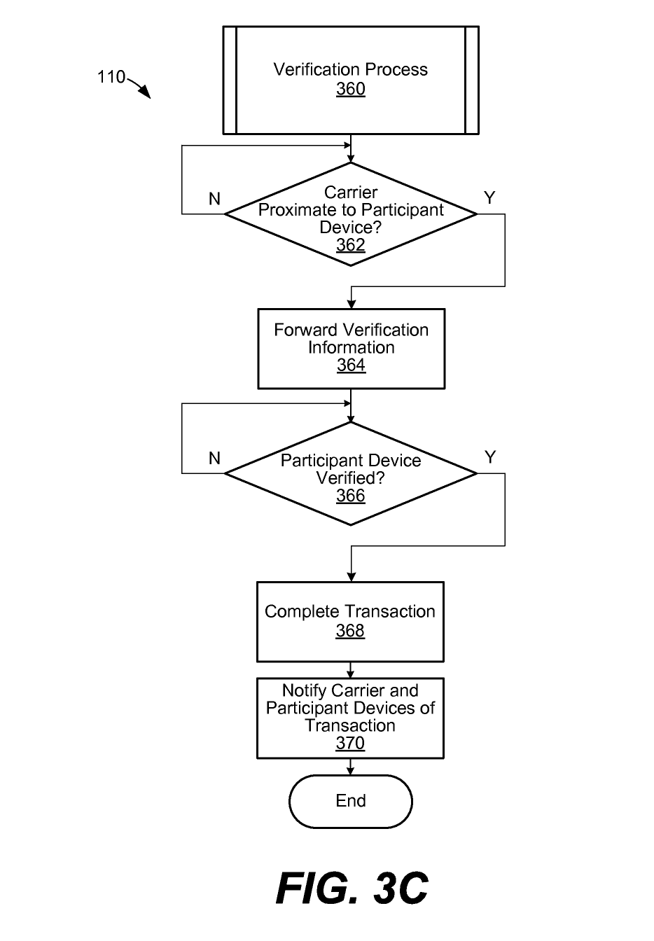

The location directed offer logic 130 includes a route evaluator 132, proximity calculator 134, offer engine 136, and transaction processor 138. As described in further detail below with reference to the process diagrams of FIGS. 3A and 3B, the route evaluator 132 is configured to evaluate or identify a route of a carrier, such as the carrier 20, in the delivery of one or more items to a certain location. In this context, the route evaluator 132 may be configured to identify preferred or likely outbound and/or return routes which may be employed by the carrier 20. As inputs, the route evaluator 132 may reference a start location for the carrier 20, an end (or return) location for the carrier 20, a current location of the carrier 20, a pickup location of an item for delivery by the carrier 20, and a delivery location for the item. Generally, the route evaluator 132 may evaluate and identify the preferred or likely routes of the carrier 20, but not necessarily direct the carrier 20 to follow any particular route. In other words, although the route evaluator 132 may direct the carrier 20 to follow a certain route, it is not necessary that the route evaluator 132 direct the actual route taken by the carrier 20 during deliveries.

The proximity calculator 134 is configured to identify participant client devices, such as the participant client devices 10-19, which are along the route identified by the route evaluator 132. For example, once a likely route of the carrier 20 is estimated, the proximity calculator 134 may identify all participant client devices 10 within a certain distance from the route. The distance may be larger or smaller, for example, depending upon the means of transportation relied upon by the carrier 20 or other factors described below. The proximity calculator 134 may be configured to first identify a number of the participant client devices 10-19 which are within a relatively wide range of the route of the carrier 20, and then reduce the number to a smaller subset of the participant client devices 10-19.

It is noted that the proximity calculator 134 need not identify the subset of the participant client devices 10-19 on the basis of proximity to the route of the carrier 20 alone. Instead, the proximity calculator 134 may identify or select one or more of the participant client devices 10-19 based on other considerations, such as the likelihood that users of the participant client devices 10-19 may accept offers, a purchase history of users, the relative movement of the users over time, etc. Thus, in various embodiments, the proximity calculator 134 may determine a subset of the participant client devices 10-19 based on the relative proximities of individual ones of the participant client devices 10-19 to the route of the carrier 20, the likelihood of acceptance of offers by the users of the participant client devices 10-19, the expected movements of the participant client devices 10-19 over time, the current location of the carrier 20, and other factors.

The offer engine 136 is configured to send offer notifications to the participant client devices 10-19 which were identified or selected by the proximity calculator 134. The offer notifications may include offers to purchase various items for expeditious delivery, for example, and different offers may be provided to individual ones of the participant client devices 10-19. An example of a user interface including an offer notification is illustrated in FIG. 5A and described in further detail below.

The transaction processor 138 is configured to complete transactions associated with the offers provided by the offer engine 136. Particularly, the transaction processor 138 is configured to complete transactions for the purchase of the items or services offered for sale by the offer engine 136. The transaction processor 138 may also verify a confluence of the locations of the carrier client device 160 and one of the participant client devices 10-19 as a measure to verify that the carrier 20 has arrived at a delivery location associated an accepted offer. For example, if a user of the participant client device 10 accepts an offer provided by the offer engine 136, when the carrier 20 arrives at or approaches the location of the participant client device 10, then the transaction processor 138 may forward a secret code, such as a QR code or number, to the participant client device 10. The carrier 20 may then verify the user of the participant client device 10 (and the device 10 itself) by confirming the QR code or number. In one embodiment, the carrier 20 may use the carrier client device 160 to scan the QR code from a display screen of the participant client device 10. In turn, the carrier client device 160 may communicate with the transaction processor 138 to compare and verify the scanned QR code with the expected QR code. If verified, then the transaction processor 138 may proceed to complete the transaction for the offer provided by the offer engine 136 and notify the carrier 20 when the transaction is complete.

It is noted, however, that the embodiments include other ways of verifying the relative (and proximate) locations of the carrier client device 160 and the participant client devices 10-19. For example, proximity detection may be verified using near-field, Bluetooth®, or other radio frequency (RF) communications. Proximity may also be verified by exchanging certain audio signals between the carrier client device 160 and the participant client devices 10-19. Further, in some embodiments, facial recognition and/or the presentation of photographs of users may be relied upon. Additional aspects of the operation of the transaction processor 138 and the verification of users and devices are described below.

The electronic commerce engine 140 is representative of any electronic commerce engine or system configured to complete transactions for the purchase of items and/or services via the network 150. That is, the electronic commerce engine 140 may be configured to present an electronic commerce marketplace or storefront to various client devices (e.g., the participant client devices 10-19 and others) via the network 150. To that end, the electronic commerce engine 140 may generate various network pages which offer items and/or services for sale. Once a transaction is completed through the electronic commerce engine 140, it may contact the carrier 20, for example, to deliver an item to a certain delivery location (e.g., the delivery location 24 in FIG. 1).

Thus, the sale of items through the electronic commerce engine 140 may trigger the operation of the location directed offer logic 130. More particularly, once a transaction is completed through the electronic commerce engine 140, the electronic commerce engine 140 may provide the details of the transaction to the location directed offer logic 130. The details may identify the carrier 20, a delivery location where the carrier 20 is expected to deliver an item pursuant to the transaction, an expected departure time of the carrier 20 in making the delivery, and an estimated and/or promised delivery time. Using those details, the location directed offer logic 130 may proceed to evaluate a route for the carrier 20, identify the participant client devices 10-19 along the route, send offer notifications to one or more of the participant client devices 10-19, and, if the offers are accepted, forward additional delivery locations to the carrier 20 based on the accepted offers. The location directed offer logic 130 may also make suggestions as to which other items the carrier 20 should carry during the delivery. In alternative embodiments, the electronic commerce engine 140 may be separate from the computing environment 110. Further, the location directed offer logic 130 may receive the transaction details from other computing systems and/or entities, such as the electronic commerce platform 180.

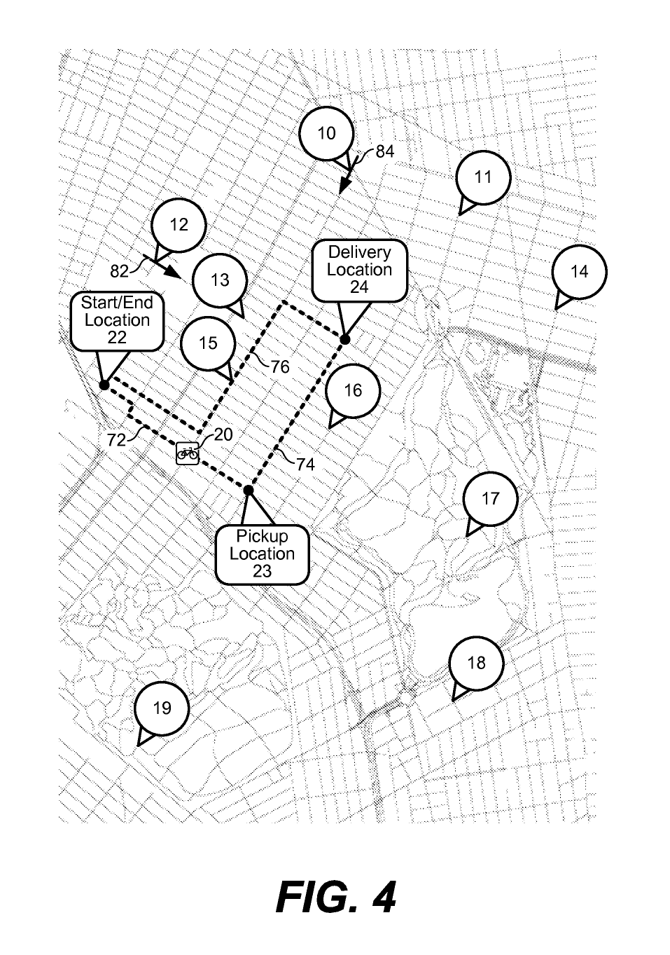

FIGS. 3A and 3B illustrate a process 300 of location directed offers performed in the networked environment 100 in FIGS. 1 and 2 according to an example embodiment of the present disclosure. Further, FIG. 4 illustrates an example map and FIGS. 5A-D illustrate example user interfaces according to aspects of the process of location directed offers in FIGS. 3A and 3B. In certain aspects, the flowcharts in FIGS. 3A and 3B may be viewed as depicting an example group of steps performed in the networked environment 100 according to one or more embodiments. It should be appreciated that that the flowchart in FIGS. 3A and 3B provides merely one example of a functional sequence or arrangement that may be employed to implement the operations of the networked environment 100, as described herein. It is noted here that, although the process 300 is described in connection with the computing environment 110 in FIGS. 1 and 2, other environments may perform the process 300 illustrated in FIGS. 3A and 3B.

Referring first to FIG. 3A, the process 300 includes receiving an order for delivery of an item via a carrier at reference numeral 302. In that context, the electronic commerce engine 140 (FIG. 2) (or the electronic commerce platform 180) may complete a transaction for the purchase of an item via the network 150. As an example, according to the order, the item is to be picked up from the pickup location 23 by the carrier 20 and delivered to the delivery location 24 in FIG. 4. In turn, the electronic commerce engine 140 communicates instructions that direct the carrier 20 to pick up the item from the pickup location 23 and deliver it to the delivery location 24. The electronic commerce engine 140 also provides details on the order to the location directed offer logic 130. Among other information, the details may identify the carrier 20, the start/end location 22 for the carrier 20, the pickup location 23, the delivery location 24, an expected departure time of the carrier 20 from the start/end location 22, a mode of transportation of the carrier 20, an expected delivery time of the item at the delivery location 24, etc.

At reference numeral 304, the process 300 includes evaluating a route for the delivery to the delivery location 24. Here, the route evaluator 132 (FIG. 2) may estimate the route which the carrier 20 may take when delivering the item to the delivery location 24. As inputs, the route evaluator 132 may reference the start/end location 22 for the carrier 20, a current location of the carrier 20 over time, the pickup location 23, and the delivery location 24.

As illustrated in FIG. 4, the route evaluator 132 may estimate the route including the pickup route 72, outbound route 74, and return route 76 segments. It should be appreciated that the route segments 72, 74, and 76 illustrated in FIG. 4 are provided by way of example only. The route evaluator 132 may evaluate or estimate the route of the carrier 20 based on various factors, such as past routes taken by the carrier 20 (or other carriers), current or anticipated traffic conditions, the mode of transportation of the carrier 20, etc. As noted above, the route evaluator 132 may evaluate and identify the preferred or likely routes of the carrier 20 at reference numeral 304, but not necessarily direct the carrier 20 to follow any particular route.

At reference numeral 306, the process 300 includes identifying participant client devices along the route estimated at reference numeral 304. In this context, the proximity calculator 134 (FIG. 2) may identify the participant client devices 10-19 in FIG. 4. The proximity calculator 134 may reference the participant client device data 126, for example, when identifying the participant client devices 10-19. At this point in the process 300, the proximity calculator 134 seeks to identify a relatively large or wide number of participant client devices within range of the route estimated at reference numeral 304.

When identifying the participant client devices 10-19 at reference number 306, the proximity calculator 134 may also identify certain characteristics associated with the participant client devices 10-19, such as the speed and direction of travel of the participant client devices 10-19 (if any), among other characteristics. The proximity calculator 134 may use this information to determine which of the participant client devices 10-19 to provide offer notifications to, as described below.

At reference numeral 308, the process 300 includes determining or identifying a subset of the plurality of participant client devices 10-19 identified at reference numeral 306 based on one or more factors. More particularly, the proximity calculator 134 may determine the subset of the plurality of participant client devices 10-19. It is noted however that, if the number of participant client devices identified at reference numeral 306 is low (e.g., one), determining a subset at reference numeral 309 may be omitted from the process 300.

Among the embodiments, the proximity calculator 134 may determine the subset based on various considerations, such as a proximity of each of the plurality of participant client devices 10-19 to the route segments 72, 74, and 76 (e.g., the certain proximity 40 in FIG. 1), a number of items which may be transported the carrier 20, the speed and direction of travel of the participant client devices 10-19, the likelihood that users of the participant client devices 10-19 may accept an offer for expeditious delivery, or other factors or combinations thereof. As described in further detail below, it is also noted that the proximity calculator 134 may identify one or more of the participant client devices 10-19 to receive offer notifications in an ongoing fashion while the carrier 20 travels between the locations 22-24.

Referring to FIG. 4 for some examples, the proximity calculator 134 may not select the participant client device 16 to be included in the subset, for example, if a delivery to the participant client device 16 before the delivery to the delivery location 24 may result in a missed commitment or promise for timely delivery to the delivery location 24. In other cases, the proximity calculator 134 may select the participant client device 16 and, if an offer is accepted by the participant client device 16, only direct the carrier 20 to make a delivery to the participant client device 16 after the delivery to the delivery location 24 has occurred.

As other examples, based on the speed and direction 82 of the participant client device 12, the proximity calculator 134 may select the participant client device 12 to be included in the subset, because the location of the participant client device 12 is likely to substantially align with the location of the carrier 20 on the return route 76 at an estimated time in the future. On the other hand, based on the speed and direction 84 of the participant client device 10, the proximity calculator 134 may not select the participant client device 10, because it is unlikely to align with the location of the carrier 20 on the return route 76.

As still another example, if the carrier 20 is only capable of carrying one additional copy of a certain book, then the proximity calculator 134 may select the participant client device 13 to be included in the subset rather than the participant client device 15, although the participant client device 15 is closer to the return route 76, so long as the participant data 124 indicates that the user of the participant client device 13 is more likely to be interested in the book than the user of the participant client device 15.

At reference numeral 310, the process 300 includes identifying one or more additional items to be carried by the carrier 20 during the delivery to the delivery location 24. These additional items may be those likely to be accepted for purchase by users of the participant client devices 10-19, for example. The identifying may be directed to the users of the devices identified and/or determined at reference numerals 306 and/or 308.

In one embodiment, the offer engine 136 may reference the participant data 124 to review the purchase history of the users of the participant client devices 10-19, in an attempt to predict or anticipate which items may be desired by the users. The offer engine 136 may also reference data stored by the electronic commerce platform 180 or other entities to the extent that such data is representative of the purchase history of the users. If the data is unavailable or inconclusive, then the offer engine 136 may simply identify items which are known to be high velocity or popular items. The offer engine 136 may also reference the item data 122 to identify which items are available for pickup by the carrier 20 at the pickup location 23 (or other locations). At reference 310, the process 300 also includes instructing the carrier 20 to carry the additional identified items. In other embodiments, the process may omit the identifying at reference numeral 310. For example, the carrier 20 may only carry one or more types of additional items, and these items may be known by the offer engine 136.

Before turning to reference numeral 312, it is noted that, among embodiments, the carrier 20 may depart for delivery of the item ordered at reference numeral 302 at any suitable time during the flow of the process 300. In other words, the carrier 20 may depart for delivery before or after the identification of items at reference numeral 310. While it may be preferred for the carrier 20 to depart after receiving the instructions regarding which additional items to carry, the carrier 20 may depart earlier than reference numeral 310. In that sense, it is also noted that sending offer notifications, as described below at reference numeral 312, may also occur before or after the carrier 20 has departed for delivery.

At reference numeral 312, the process 300 includes sending an offer notification to each of the participant computing devices determined in the subset at reference numeral 308. Referring to FIG. 4, if the subset determined at reference numeral 308 includes the participant client devices 13 and 15, then the offer engine 136 would send offer notifications to the participant client devices 13 and 15.

FIG. 5A provides an example of an offer notification on the participant client device 13. It is noted that the user interface illustrated in FIG. 5A (and in FIGS. 5B-5F) is provided as a representative example interface and is not intended to be limiting or exhaustive. Instead, various types and styles of user interfaces may be relied upon among embodiments.

As illustrated in FIG. 5A, the offer notification indicates that the user of the participant client device 13 has the opportunity to purchase item “X” for delivery in about “Y” minutes. The delivery time may be estimated by the offer engine 136 based on the current location of the carrier 20 and other related factors, such as traffic conditions, etc. Although not illustrated in FIG. 5A, the offer notification may include a statement regarding the cost of item “X” and/or the on-location delivery of item “X”. The statement may indicate that item “X” is being offered at a reduced cost, for example, and/or that the on-location, expeditious delivery of item “X” is being offered at low or no cost. The user has the options of accepting the offer, declining the offer, or forwarding the offer. In some cases, the offer may be forwarded to other nearby participant client devices. It is noted that the offer notification illustrated in FIG. 5A may appear on a lockscreen of the participant client device 13, for example, or in the directed offer application (e.g., ref. 172 in FIG. 2) executing on the device 13.

In the embodiment shown in FIG. 5A, the offer is associated with an offer expiration time period of two minutes, although other expiration times are possible. It is noted that, among embodiments, the offer expiration time may be determined dynamically for each offer notification. The offer expiration time associated with an offer notification may vary, for example, depending upon the current location of the carrier 20, the relative locations of the carrier 20 and the participant client device 13, the number of participant client devices identified at reference numeral 306, and other factors. As another example, the offer expiration time may be shorter when a greater number of participant client devices are identified at reference numeral 306 and longer when a smaller number are identified. Once the offers have been sent to the participant client devices 13 and 15, the process 300 proceeds to reference numeral 314 to wait for any acceptances during the expiration time period and associated deliveries. In FIG. 3B a more detailed view of the processes embodied at reference numeral 314 are provided. It is noted that the process in FIG. 3B may occur for each participant client device which receives an offer at reference numeral 312. Thus, in the present example, the process in FIG. 3B may occur for both the participant client devices 13 and 15. For simplicity, the process in FIG. 3B is described only in the context of the participant client device 13.

At reference numeral 330, the offer engine 136 may determine if the offer expiration time has expired. It is noted that, at least in one embodiment, offers sent by the offer engine 136 are limited in duration. In that way, if a user of the participant client device 13 does not notice or ignores the offer, it may be provided to another participant client device after the offer expiration time. If the offer expiration time has expired, then the process proceeds to reference numeral 332, which includes sending a follow-up offer to the user of the participant client device 13. After sending the follow-up offer at reference numeral 332, the process 300 proceeds back to reference numeral 316 in FIG. 3A.

FIG. 5B provides an example follow-up offer interface for sending a follow-up offer to the participant client device 13. As illustrated, the follow-up offer indicates that the user of the participant client device 13 missed an offer for on-location delivery of item “X”, but provides a user interface option to order item “X” for home delivery. In other cases, the interface may also indicate that the on-location delivery offer was made at a reduced price, that the option for home delivery of item “X” is being offered at a reduced price, that the option for home delivery is being offered at a reduced delivery cost, etc.

Referring back to FIG. 3B, if the offer expiration time has not expired at reference numeral 330, then the process 300 proceeds to reference numeral 334, which includes determining whether an offer acceptance has been received. In that context, the offer engine 136 may monitor for an acceptance of the offer sent to the participant client device 13. If the offer is accepted by a user of the participant client device 13, the offer engine 136 and the transaction processor 138 may use standard billing and/or payment information for the user, as stored in the participant data 124, to complete the transaction. When the offer is accepted, then the process 300 proceeds to reference numeral 336. Otherwise, the process 300 proceeds back to reference numeral 330.

At reference numeral 336, the process 300 includes reevaluating the route of the carrier 20 and identifying current locations of the carrier 20 and the participant client device 13. Particularly, the route evaluator 132 may identify a current location of the carrier 20 and the participant client device 13 at the time of the acceptance of the offer. It is noted that, at least in one embodiment, it is not required that the carrier 20 follow any specific route. Thus, the route evaluator 132 may reevaluate the current location of the carrier 20 with respect to the current location of the participant client device 13 after the acceptance of the offer is received from the participant client device 13. It is also noted that, according to aspects of the embodiments, the location directed offer logic 130 may periodically receive location data from various participant and carrier client devices.

At reference numeral 337, the process 300 includes forwarding additional order details to the carrier 20. More particularly, the offer engine 136 may forward to the carrier client device 160 (FIG. 2) an identifier of the item sold according to the offer sent to and accepted at the participant client device 13. The offer engine 136 may also forward, as an additional delivery location, the current location of the participant client device 13. With those additional order details, the carrier 20 has the information needed to locate and deliver the additional item to the location of the user of the participant client device 13.

At reference numeral 338, the process 300 includes calculating an estimated delivery time for delivery to the location of the participant client device 13. Here, the route evaluator 132 may calculate the estimated delivery time. At reference numeral 340, the process 300 includes communicating the delivery time to the participant client device 13.

FIG. 5C provides an example interface provided on the participant client device 13 after acceptance of an offer. As illustrated, the interface indicates that delivery is expected to occur in about four minutes. The interface also provides the user with an opportunity to cancel the order and to observe a current location of the carrier 20. The interface in FIG. 5C is provided by way of example and may include other information in certain cases. For example, the interface may include an instruction for the user of the participant client device 13 to remain at his current location. In other cases, the interface may instruct the user to proceed to and wait at a certain location, such as a storefront, bus stop, street intersection, etc. Thus, in certain embodiments, the offer acceptance interface may provide a short list of instructions to facilitate delivery.

FIG. 5D provides an example interface to observe the current location of the carrier 20. With reference to the view in FIG. 5D, the user of the participant client device 13 may be able to approach the position of the carrier 20 and shorten the delivery time. Further, although not illustrated, the carrier client device 160 may include a view of the position of the participant client device 13 similar to that shown in FIG. 5D.

Referring back to FIG. 3B, at reference numeral 342, the process 300 determines whether the delivery is complete. If the transaction with the user of the participant client device 13 is complete (e.g., the additional item has been delivered to the user), then the process 300 proceeds to back to reference numeral 316 in FIG. 3A. If the transaction is not complete, then the process 300 proceeds from reference numeral 342 to reference numeral 344. At reference numeral 344, the process 300 includes determining whether the delivery has been cancelled by the user of the participant client device 13. If so, then the process 300 proceeds to back to reference numeral 316 in FIG. 3A. Otherwise, the process 300 proceeds back to reference numeral 342 to wait for the delivery to occur.

Referring back to FIG. 3A, after waiting for any acceptances and deliveries to occur for the participant client devices 13 and 15, the process 300 proceeds to reference numeral 316, which includes determining whether any offers are still available. In that context, the offer engine 136 may determine whether the carrier 20 still carries one or more items for which offer notifications may be sent to devices other than the participant client devices 13 and 15. For example, if offers sent to the participant client devices 13 and 15 are declined, then the process 300 may proceed back to reference numeral 306 to identify other participant client devices to which offer notifications may be sent. The process 300 may continue until the carrier 20 sells all additional items carried, the carrier 20 returns to the start/end location 22, for example, the carrier 20 begins a route for another delivery, or at some other specified or predetermined time.

According to other aspects of the embodiments, FIG. 3C illustrates a process 360 of participant device verification performed in the networked environment 100 in FIGS. 1 and 2 according to an example embodiment of the present disclosure. In the following paragraphs, the process 360 is described in the context of the carrier 20 and the participant client device 13, but it should be appreciated that the process may be applied between any carrier and participant client device.

At reference numeral 362, the process 360 includes determining whether the carrier 20 is proximate or within a certain distance to the participant client device 13. In that context, after an offer is accepted by the user of the participant client device 13, the transaction processor 138 may determine whether the carrier 20 is relatively close to or approaching the participant client device 13. If so, the process 360 proceeds to reference numeral 364. Otherwise, the process proceeds back to reference numeral 362.

At reference numeral 364, the process 360 includes the transaction processor 138 forwarding verification information to the participant client device 13. For example, the transaction processor 138 may forward a secret code, such as a QR code or number, to the participant client device 13. In that context, FIG. 5E illustrates an example user interface including verification information on its display screen. This verification information may be provided to the carrier 20 when the carrier 20 finally meets the user of the participant client device 13.

At reference numeral 364, the embodiments may include any suitable way of verifying participant client devices. For example, proximity detection may be verified using near-field, Bluetooth®, or other radio frequency (RF) communications. Proximity may also be verified by exchanging certain audio signals between the carrier client device 160 and the participant client devices 10-19. Further, in some embodiments, facial recognition and/or the presentation of photographs of users may be relied upon. If a QR code is communicated to the participant client device 13, the carrier 20 may use the carrier client device 160, for example, to scan the QR code from the display screen of the participant client device 13. In turn, the carrier client device 160 may communicate with the transaction processor 138 to compare and verify the scanned QR code with an expected one at reference numeral 366.

If the participant client device 13 is verified, then the transaction processor 138 may proceed to complete the transaction at reference numeral 368. Otherwise, the process 360 waits at reference numeral 366 for at least a reasonable period of time for a delivery verification to occur before the additional delivery is cancelled.

As noted above, once the participant client device 13 is verified at reference numeral 366, the process proceeds to reference numeral 368 where the transaction processor 138 proceeds to complete the transaction for the purchase of the additional item by the user of the participant client device 13. The transaction processor 138 may use standard billing and/or payment information for the user, as stored in the participant data 124, to complete the transaction.

Finally, at reference numeral 370, the process 300 includes the transaction processor 138 notifying the carrier 20 that the transaction with the user of the participant client device 13 is complete. That notification may be provided to the carrier client device 160. The process 300 may also include sending a notification to the participant client device 13, an example of which is shown in FIG. 5F. Once notified that the transaction is complete, the carrier 20 may transfer the additional item to the user of the participant client device 13 to finish the transaction.

FIG. 6 illustrates an example schematic block diagram of the computing environment 110 employed in the networked environment 100 of FIGS. 1 and 2 according to various embodiments of the present disclosure. The computing environment 110 includes one or more computing devices 600. Each computing device 600 includes at least one processing system, for example, having a processor 602 and a memory 604, both of which are electrically and communicatively coupled to a local interface 606. To this end, each computing device 600 may be embodied as, for example, at least one server computer or similar device. The local interface 606 may be embodied as, for example, a data bus with an accompanying address/control bus or other bus structure as can be appreciated.

In various embodiments, the memory 604 stores data and software or executable-code components executable by the processor 602. For example, the memory 604 may store executable-code components associated with the location directed offer logic 130 and the electronic commerce engine 140 for execution by the processor 602. The memory 604 may also store data such as that stored in the directed offer data store 120, among other data.

It should be understood and appreciated that the memory 604 may store other executable-code components for execution by the processor 602. For example, an operating system may be stored in the memory 604 for execution by the processor 602. Where any component discussed herein is implemented in the form of software, any one of a number of programming languages may be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, in various embodiments, the memory 604 stores software for execution by the processor 602. In this respect, the terms “executable” or “for execution” refer to software forms that can ultimately be run or executed by the processor 602, whether in source, object, machine, or other form. Examples of executable programs include, for example, a compiled program that can be translated into a machine code format and loaded into a random access portion of the memory 604 and executed by the processor 602, source code that can be expressed in an object code format and loaded into a random access portion of the memory 604 and executed by the processor 602, or source code that can be interpreted by another executable program to generate instructions in a random access portion of the memory 604 and executed by the processor 602, etc. An executable program may be stored in any portion or component of the memory 604 including, for example, a random access memory (RAM), read-only memory (ROM), magnetic or other hard disk drive, solid-state, semiconductor, or similar drive, universal serial bus (USB) flash drive, memory card, optical disc (e.g., compact disc (CD) or digital versatile disc (DVD)), floppy disk, magnetic tape, or other memory component.

In various embodiments, the memory 604 may include both volatile and nonvolatile memory and data storage components. Volatile components are those that do not retain data values upon loss of power. Nonvolatile components are those that retain data upon a loss of power. Thus, the memory 604 may include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM may include, for example, a static random access memory (SRAM), dynamic random access memory (DRAM), or magnetic random access memory (MRAM), and/or other similar memory device. The ROM may include, for example, a programmable read-only memory (PROM), erasable programmable read-only memory (EPROM), electrically erasable programmable read-only memory (EEPROM), or other similar memory device.

Also, the processor 602 may represent multiple processors 602 and/or multiple processor cores and the memory 604 may represent multiple memories that operate in parallel, respectively, or in combination. Thus, the local interface 606 may be an appropriate network or bus that facilitates communication between any two of the multiple processors 602, between any processor 602 and any of the memories 604, or between any two of the memories 604, etc. The local interface 606 may include additional systems designed to coordinate this communication, including, for example, a load balancer that performs load balancing. The processor 602 may be of electrical or of some other available construction.

As discussed above, the location directed offer logic 130 may be embodied, in part, by software or executable-code components for execution by general purpose hardware. Alternatively the same may be embodied in dedicated hardware or a combination of software, general, specific, and/or dedicated purpose hardware. If embodied in such hardware, each can be implemented as a circuit or state machine, for example, that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart or process diagrams in FIGS. 3A-3C are representative of certain processes, functionality, and operations of embodiments discussed herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 602. The machine code may be converted from the source code, etc. Further, each block may represent, or be connected with, a circuit or a number of interconnected circuits to implement a certain logical function or process step.

Although the flowchart or process diagrams in FIGS. 3A-3C illustrate a specific order, it is understood that the order may differ from that which is depicted. For example, an order of execution of two or more blocks may be scrambled relative to the order shown. Also, two or more blocks shown in succession in FIGS. 3A-3C may be executed concurrently or with partial concurrence. Further, in some embodiments, one or more of the blocks shown in FIGS. 3A-3C may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the location directed offer logic 130 that are embodied, at least in part, by software or executable-code components, may be embodied or stored in any tangible or non-transitory computer-readable medium or device for execution by an instruction execution system such as a general purpose processor. In this sense, the logic may be embodied as, for example, software or executable-code components that can be fetched from the computer-readable medium and executed by the instruction execution system. Thus, the instruction execution system may be directed by execution of the instructions to perform certain processes such as those illustrated in FIGS. 3A-3C. In the context of the present disclosure, a “computer-readable medium” can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium may include a RAM including, for example, an SRAM, DRAM, or MRAM. In addition, the computer-readable medium may include a ROM, a PROM, an EPROM, an EEPROM, or other similar memory device.

Further, any logic or application(s) described herein, including the adaptive topic logic, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment 110. Additionally, it is understood that terms such as “application,” “service,” “system,” “engine,” “module,” and so on may be interchangeable and are not intended to be limiting.

Disjunctive language, such as the phrase “at least one of X, Y, or Z,” unless specifically stated otherwise, is to be understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A non-transitory computer-readable medium embodying computer-readable program instructions thereon that, when executed by at least one computing device, directs the at least one computing device to perform a method comprising:
receiving an order for delivery of an item via a carrier, the order including a delivery location for the item;
evaluating a route for the delivery of the item to the delivery location;
identifying a plurality of participant computing devices along the route;
determining a first subset of the plurality of participant computing devices based at least in part on a proximity of the plurality of participant computing devices to the route;
determining a second subset of participant computing devices from the first subset of the plurality of participant computing devices based at least in part on at least one of a likelihood that one or more users associated with the second subset of the plurality of participant computing devices will accept an offer for at least one other item or an expected movement of the plurality of participant computing devices;
sending, during the delivery of the item by the carrier, an offer notification for the at least one other item to each of the participant computing devices in the second subset of participant computing devices, each offer notification including an offer expiration time;
receiving an offer acceptance from at least one of the plurality of participant computing devices in the second subset of participant computing devices;
based at least in part on the offer acceptance, forwarding, to a carrier client device associated with the carrier, an identifier of the at least one other item to be delivered to an additional delivery location associated with the at least one of the plurality of participant computing devices;
transmitting a participant unique code to the at least one of the plurality of participant computing devices;
receiving a scanned unique code from the carrier client device, the scanned unique code being captured by the carrier client device from a display of the at least one of the plurality of participant computing devices;
comparing the scanned unique code with the participant unique code;
verifying the at least one of the plurality of participant computing devices being proximate to the carrier client device at the additional delivery location based at least in part on the comparing of the scanned unique code with the participant unique code;
in response to success of the verifying, completing a transaction for purchase of the at least one other item; and
notifying the carrier client device and the at least one of the plurality of participant computing devices that the transaction is complete.

2. The non-transitory computer-readable medium of claim 1, wherein the method further comprises:
calculating an estimated delivery time for delivery of the at least one other item to the additional delivery location; and
communicating the estimated delivery time to the at least one of the plurality of participant computing devices.

3. The non-transitory computer-readable medium of claim 1, wherein the method further comprises:
based at least in part on whether the at least one other item is still available, identifying at least one other participant computing device along the route; and
sending an offer notification to the at least one other participant computing device.

4. A system, comprising:
a memory device to store computer-readable program instructions thereon; and
at least one computing device configured, through execution of the computer-readable program instructions, to:
identify a participant computing device along a route for delivery of a first item to a delivery location based at least in part on at least one of a likelihood that a user associated with the participant computing device will accept an offer for a second item or an expected movement of the participant computing device;
during delivery of the first item to the delivery location by a carrier, send an offer notification for purchase of the second item carried by the carrier to the participant computing device, the offer notification including an offer expiration time;
receive an offer acceptance from the participant computing device, the offer acceptance including an offer acceptance location;
in response to receiving the offer acceptance, calculate an estimated delivery time for delivery of the second item to the offer acceptance location by the carrier;
communicate the estimated delivery time to the participant computing device;
forward the offer acceptance location to a carrier computing device associated with the carrier as an additional delivery location;
transmit a participant unique code to the participant computing device;
receive a scanned unique code from the carrier computing device, the scanned unique code being captured by the carrier computing device from a display of the participant computing device;
verify the participant computing device being proximate to the carrier computing device at the additional delivery location based at least in part on a comparison of the scanned unique code with the participant; and
complete a transaction via an electronic commerce system for purchase of the second item.

5. The system of claim 4, wherein the at least one computing device is further configured to:
determine whether at least one other item is still available after the offer expiration time;
based at least in part on whether the at least one other item is still available, identify at least one other participant computing device along the route; and
send an offer notification for the at least one other item to the at least one other participant computing device.

6. The system of claim 4, wherein the at least one computing device is further configured to:
evaluate the route for the delivery at the delivery location;
identify a plurality of participant computing devices along the route; and
determine a subset of the plurality of participant computing devices.

7. The system of claim 6, wherein the at least one computing device is further configured to determine whether individual ones of the plurality of participant computing devices are within a predetermined distance to the route for the delivery.

8. The system of claim 6, wherein the at least one computing device is further configured to predict whether individual ones of the plurality of participant computing devices are likely to be within a predetermined distance to the route for the delivery over a period of time.

9. The system of claim 8, wherein the at least one computing device is further configured to send an offer notification to each of the plurality of participant computing devices in the subset of the plurality of participant computing devices.

10. The system of claim 4, wherein the participant computing device comprises a mobile computing device.

11. The system of claim 4, wherein the at least one computing device is further configured to:
notify at least one of the carrier computing device or the participant computing device that the transaction is complete.

12. The system of claim 4, wherein the at least one computing device is further configured to:
identify the second item as being one likely to be accepted by a user of the participant computing device based at least in part on a purchase history of the user; and
instruct the carrier to carry the second item during the delivery.

13. A method, comprising:
evaluating, by at least one computing device, a route for delivery of a first item to a delivery location;
identifying, by the at least one computing device, a participant computing device along the route based at least in part on at least one of a proximity of the participant computing device to a carrier, a likelihood that a user associated with the participant computing device will accept an offer for a second item, or an expected movement of the participant computing device;
sending, by the at least one computing device during the delivery of the first item to the delivery location by the carrier, an offer notification for purchase of the second item carried by the carrier to the participant computing device, the offer notification including an offer expiration time;
receiving, by the at least one computing device, an offer acceptance from the participant computing device;
in response to receiving the offer acceptance, forwarding, by the at least one computing device, an additional delivery location for the second item to a carrier computing device associated with the carrier;
transmitting a participant unique code to a participant computing device;
receiving a scanned unique code from the carrier computing device, the scanned unique code being captured by the carrier computing device via a display of the participant computing device;
verifying the participant computing device being proximate to the carrier computing device based at least in part on a comparison of the scanned unique code with the participant unique code; and
completing a transaction of a purchase of the second item via an electronic commerce system in response to the verifying of the participant computing device being proximate to the carrier computing device.

14. The method of claim 13, further comprising:
in response to receiving the offer acceptance, calculating, by the at least one computing device, an estimated delivery time for delivery of the second item to add; and
communicating, by the at least one computing device, the estimated delivery time to the participant computing device.

15. The method of claim 13, further comprising:
determining, by the at least one computing device, whether at least one other item is still available after the offer expiration time;
based at least in part on determining that the at least one other item is still available, identifying, by the at least one computing device, at least one other participant computing device along the route; and
sending, by the at least one computing device, an offer notification for the at least one other item to the at least one other participant computing device.

16. The method of claim 13, wherein identifying the participant computing device along the route comprises:
identifying, by the at least one computing device, a plurality of participant computing devices along the route; and
determining, by the at least one computing device, a subset of the plurality of participant computing devices based at least in part on a proximity of individual ones of the plurality of participant computing devices to the route.

17. The method of claim 16, wherein sending the offer notification comprises sending an offer notification to each of the plurality of participant computing devices in the subset of the plurality of participant computing devices.

18. The method of claim 16, wherein at least one of the plurality of participant computing devices comprises a mobile computing device.

19. The method of claim 13, further comprising:
notifying the carrier that the transaction is complete.

20. The method of claim 13, further comprising:
identifying the second item as being one likely to be accepted by a user of the participant computing device based at least in part on a purchase history of the user; and
instructing the carrier to carry the second item during the delivery.
